(19) United States
(12) Patent Application Publication
(10) Pub. No.: US 2024/0211831 A1
(43) Pub. Date: Jun. 27, 2024

(54) SYSTEM AND METHOD FOR MANAGING ISSUES THROUGH PROFICIENCY ANALYSIS

(71) Applicant: Dell Products L.P., Round Rock, TX (US)

(72) Inventors: ANNE-MARIE MCREYNOLDS, San Jose, CA (US); MING QIAN, Allston, MA (US); CHRISTOPHER O'BRYON HILL, Bellevue, WA (US)

(21) Appl. No.: 18/145,083

(22) Filed: Dec. 22, 2022

(51) Int. Cl. G06Q 10/0631; G06Q 30/015

(52) U.S. Cl. CPC G06Q 10/063112; G06Q 30/015

(57) ABSTRACT

Methods and systems for managing customer-encountered issues are disclosed. To manage the customer-encountered issues, a ranking process and multifactor selection process may be implemented to select a service agent to resolve each customer-encountered issue. The rankings ascribed to be service agents may be based on the proficiency levels of the service agents to resolve customer-encountered issues. The proficiency levels may be based on quantifiable information, and may be obtained using an automated process. During selection, the rankings and factors such as current workload may be taken into account to improve the likelihood that goals for working the customer-encountered issues are more likely to be met.

### FIELD

Embodiments disclosed herein relate generally to issue management. More particularly, embodiments disclosed herein relate to systems and methods to manage issues through optimization.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows, processes, and other aspects of a system in accordance with an embodiment.

FIG. 3 shows a flow diagram illustrating a method of resolving customer-encountered issues in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing customer-encountered issues. To manage the customer-encountered issues, service requests for the customer-encountered issues may be serviced by service agents. However, the number of service agents may be limited thereby limiting the customer-encountered issues that may be serviced per unit time. Additionally, in the event that a service agent is assigned to resolve a service request but fails, the service request may be escalated and assigned to another service agent to resolve thereby further reducing the rate of resolution and increasing time to resolution. Further, even if a proficient service agent is assigned to resolve a service request, the assigned service agent may do so in a time inefficient manner depending on the service agent's level of proficiency in resolving customer-encountered issues.

To improve the rate of resolving customer-encountered issues within prescribed time goals, the performance of service agents for previously remediated customer-encountered issues may be quantified and analyzed to obtain number of metrics regarding the performance. The number of metrics may include resolution rates for customer-encountered issues, reopening rates for customer-encountered issues, first contact resolution rates for customer-encountered issues, and escalation rates for customer-encountered issues.

The number of metrics may be used to obtain a cumulative metrics representing an overall performance levels of the service agents. For example, the number of metrics may be summed and/or otherwise used to obtain a cumulative metric for a service agent.

The cumulative metrics for each of the service agents may be used to rank the service agents with respect to their likely level of proficiency (e.g., estimated level) for resolving new customer-encountered issues.

The rankings of the service agents may be used in combination with other factors such as goals for completing resolution of the customer-encountered issue (e.g., time, cost, etc.), current workload of the service agents, impact of assigning each service agent to work the customer-encountered issue, and/or other factors to select one of the service agents to work each of the customer-encountered issue.

The selected service agent may be assigned to work the customer-encountered issue until resolved, escalated, and/or otherwise completed. Once work on the customer-encountered issue is complete (at least temporarily), information regarding the performance of the service agent and the customer-encountered issue may be recorded so that future assignment processes may be more likely to result in desired outcomes (e.g., resolutions of customer-encountered issues within prescribed goals).

Thus, embodiments disclosed herein may address the technical problem of resource limitations in response management systems. Due to limited availability of resources, only certain numbers and types of remediation processes may be implemented per unit time. By performing a ranking an multifactor analysis of the service agents, the limited quantity of resources (e.g., service agents) may be able to resolve more customer-encountered issues per unit time and in accordance with prescribed goals.

In an embodiment, a method for managing customer-encountered issues using service agents is provided. The method may include identifying a portion of the service agents that are qualified to handle a customer-encountered issue of the customer-encountered issues; ranking the service agents of the portion of the service agents based on proficiency level estimates for resolving the customer-encountered issue by the service agents to obtain a ranking for the portion of the service agents, the proficiency level estimates being based on historical performance of the service agents and an automated quantification model; selecting a service agent of the service agents to remediate the customer-encountered issue based on the ranking; and resolving the customer-encountered issue by assigning the selected service agent to work the customer-encountered issue.

The automated quantification model may provide, for a service agent of the service agents, a proficiency level estimate of the proficiency level estimates based on a group of rates consisting of: a resolution rate of previously remediated customer-encountered issues by the service agent; a reopening rate of the previously remediated customer-encountered issues by the service agent; a first contact resolution rate of the previously remediated customer-encountered issues by the service agent; and an escalation rate of the previously remediated customer-encountered issues by the service agent.

The resolution rate may indicate a ratio of the previously remediated customer-encountered issues that were resolved by the service agent to a total of the previously remediated customer-encountered issues that were assigned to be resolved by the service agent.

The reopening rate may indicate a ratio of the previously remediated customer-encountered issues that were credited as resolved by the service agent but that were reopened for additional work toward being resolved to a total of the previously remediated customer-encountered issues that were assigned to be resolved by the service agent.

The first contact resolution rate may indicate a ratio of the previously remediated customer-encountered issues that were credited as resolved by the service agent and that were not reopened for additional work toward being resolved to a total of the previously remediated customer-encountered issues that were assigned to be resolved by the service agent.

The escalation rate may indicate a ratio of the previously remediated customer-encountered issues that were assigned to the service agent for resolution but that were subsequently resolved by a different service agent of the service agents to a total of the previously remediated customer-encountered issues that were assigned to be resolved by the service agent.

The proficiency level estimate of the proficiency level estimates may be obtained using a weighted sum of the group of rates that is normalized to a proficiency level scale for the service agents.

A non-transitory media may include instructions that when executed by a processor cause the computer-implemented method to be performed.

A data processing system may include the non-transitory media and a processor, and may perform the computer-implemented method when the computer instructions are executed by the processor.

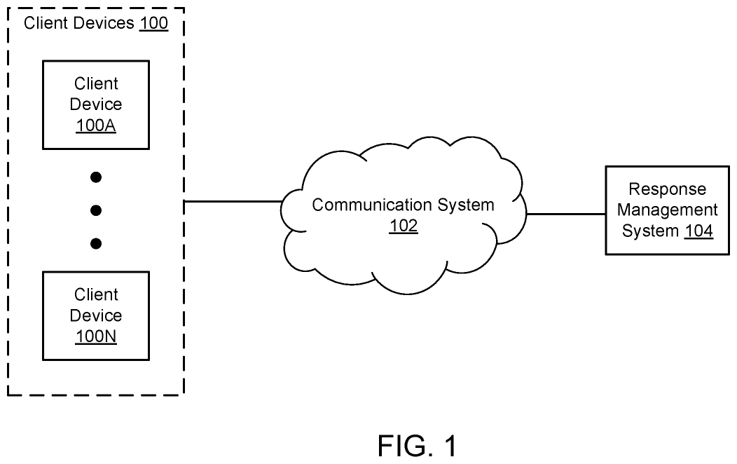

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer-implemented services, the system may include any number of client devices 100. Client devices 100 may provide the computer implemented services to users of client devices 100 and/or to other devices (not shown). Different client devices (e.g., 100A, 100N) may provide similar and/or different computer implemented services.

To provide the computer-implemented services, client devices 100 may include various hardware components (e.g., processors, memory modules, storage devices, etc.) and host various software components (e.g., operating systems, application, startup managers such as basic input-output systems, etc.). These hardware and software components may provide the computer-implemented services via their operation.

To provide certain computer-implemented services, the hardware and/or software components of client devices 100 may need to operate in predetermined manners. If the hardware and/or software components do not operate in the predetermined manners, then a client device may be unable to provide all, or a portion, of the computer-implemented services that it normally provides (and may be expected by the users of the client device to reliably provide).

The hardware and/or software components of client devices 100 may operate differently (e.g., in an undesirable manner) from the predetermined manners for any number of reasons. For example, any of the hardware and/or software components may malfunction. In another example, the hardware and/or software components may be operating nominally but in undesirable manners through various interactions such as resource conflicts or constraints. In a further example, various configuration settings of the hardware and/or software components may be set (intentionally or inadvertently) in a manner that causes the operation of any of client devices 100 to be undesirable. The hardware and/or software components of client devices 100 may operate different from the predetermined manners for other reasons (e.g., various root causes) without departing from embodiments disclosed herein. Thus, a client device may not provide its computer-implemented services for any number of reasons which may be difficult to identify.

The undesired operation of client devices 100 may take any number of forms which may be linked to a root cause of the undesired operation. For example, an undesired operation of a client device may be a lack of operation such as failing to power on when a power button is depressed. In another example, an undesired operation of a client device may be a failure of the client device to utilize a full width of a display when presenting information to a user via the display. In a further example, an undesired operation of a client device may be inconsistent operation of the client device over time such as the client device intermittently freezing for periods of time during which the client device is unresponsive to a user and/or other devices. The undesired operation of client devices 100 may manifest in other manners without departing from embodiments disclosed herein. Thus, a client device may manifest any number of undesired operations which may be due to any number of root causes.

To improve the likelihood of client devices 100 providing desired computer implemented services, the system of FIG. 1 may include response management system (RMS) 104. RMS 104 may be tasked with addressing undesired operation of any of client devices 100. However, RMS 104 may have limited resources with which to address the undesired operation of client devices 100.

In general, embodiments disclosed herein may provide methods, systems, and/or devices for managing undesired operation of client devices 100. To manage the undesired operation (e.g., also referred to as a “client encountered issue”) of client devices 100, RMS 104 may provide remediation services to address the undesired operation of client devices 100. The remediation services may include diagnosing, managing, and otherwise resolving the undesired operation.

To provide the remediation services, service agents (e.g., trained persons) may be assigned to address the undesired operation of client devices 100. However, the number of service agents available to work the customer-encountered issues to resolution may be limited.

To improve the rate of resolution of the customer-encountered issue, the system may (i) analyze previously resolved customer-encountered issues to identify levels of proficiency of the service agents using an automated quantification model, (ii) when new customer-encountered issues are identified, use the identified levels of proficiency as estimates for the abilities of the service agents to resolve the new customer-encountered issues and rank the service agents accordingly based on the estimates, and/or (iii) assign service agents to work customer-encountered issues based on the rankings, estimates, and/or other factors (e.g., goals for resolution of the customer-encountered issues and factors such as current workload that may indicate that an even highly ranked service agent may not be able to complete the resolution in a manner that meets the goals) to resolve the customer-encountered issues.

To initially identify service agents that are proficient in resolving customer-encountered issues, the system may identify (i) a level of support likely to be required to resolve customer-encountered issues (e.g., based on cognitive load analysis of customer-encountered issues) and (ii) levels of skills of the service agents (e.g., based on taxonomic analysis of customer-encountered issues). The available service agents may be filtered to identify a set of service agents that both meet the expected level of support and are likely to have the skills needed to resolve the customer-encountered issues.

Once the set of service agents are identified, the system may (i) estimate the level of proficiency that the set of service agents have demonstrated with respect to customer-encountered issues in the past, (ii) use the levels of proficiency to rank the set of service agents with respect to one another, and (iii) use the ranking, estimates, and other factors (e.g., the current workload and other factors that may limit the ability of the set of service agent to take on a new workload and timely complete it) to select a service agent for assignment to resolve each customer-encountered issue. Once selected, the service agent may be assigned to work the customer-encountered issue (e.g., until remediated or other outcome such as reassignment/escalation to be worked by other service agents).

By doing so, resolution of customer-encountered issues may be improved thereby providing reduced time to resolution, reduced rates of reopening work on customer-encountered issues that were previously worked on, and/or other benefits. For example, by selecting the service agents in the manner disclosed herein, the likelihood of remediations being attempted but unsuccessfully completed. Consequently, these customer-encountered issues may be less likely to be worked on by service agents that are unlikely to resolve the customer-encountered issues. Accordingly, the customer-encountered issues may be remediated more quickly on average by avoiding (i) failed attempts at resolution by service agents, (ii) delays in escalation of failed attempts at resolution, and/or (iii) other delays in resolution of customer-encountered issues due to initial assignment of customer-encountered issues to service agents that are unlikely to be able to resolve the issues.

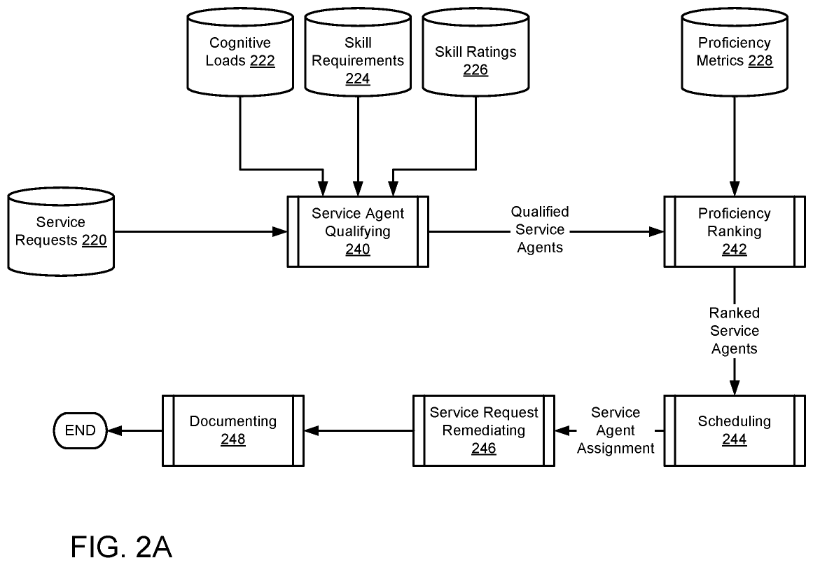

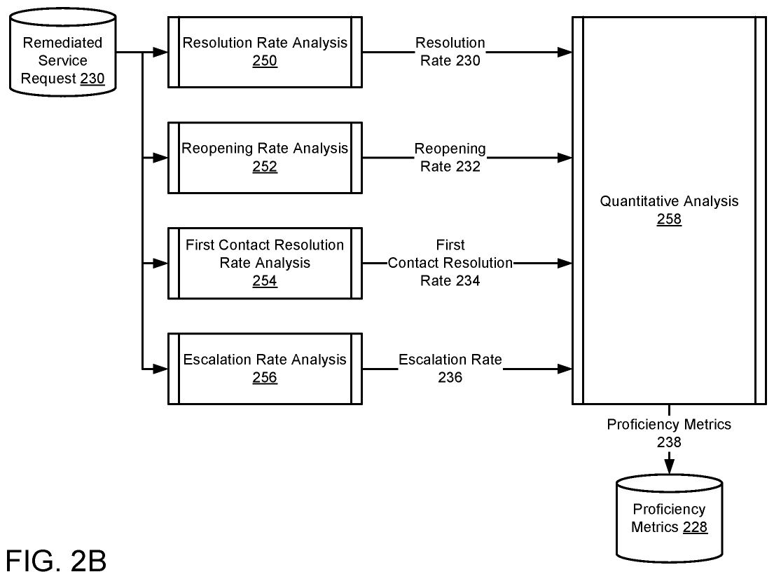

To provide the remediation services, RMS 104 may (i) receive information (e.g., telemetry data such as error alerts, logs that indicate operation of a client device, etc.) from users of client devices 100 regarding various customer-encountered issues (e.g., undesired operation of client devices 100 encountered by users thereof) with respect to client devices 100, (ii) perform skill level and support level analysis to identify a set of service agents likely to be proficient in resolving the customer-encountered issues, (iii) perform proficiency estimation analysis and scheduling analysis with respect to the proficient service agents to identify one of the proficient service agents likely to be able to remediate the customer-encountered issue withing prescribed goals (e.g., time, cost, etc.), (iv) assign the identified service agent to work the customer-encountered to resolution (or until escalated due to failure to resolve the customer-encountered issue, transferred to a different service agent for workload balancing or other purposes, etc.), and/or (v) document the resolution so that future assignments of service agents are completed using up to date information (e.g., thereby improving the quality of estimated level of proficiency of the service agents). Refer to FIGS. 2A-B for additional details regarding assignment of service agents to work customer-encountered issues.

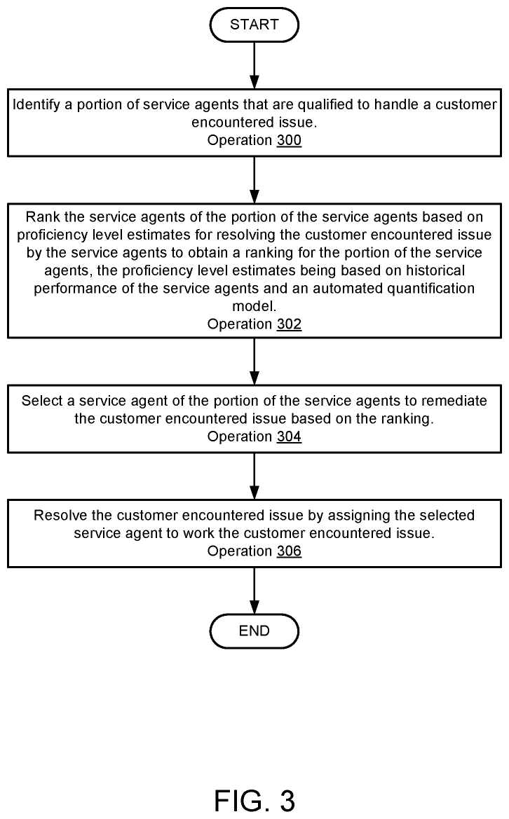

When providing its functionality, RMS 104 may perform all, or a portion, of the methods illustrated in FIG. 3.

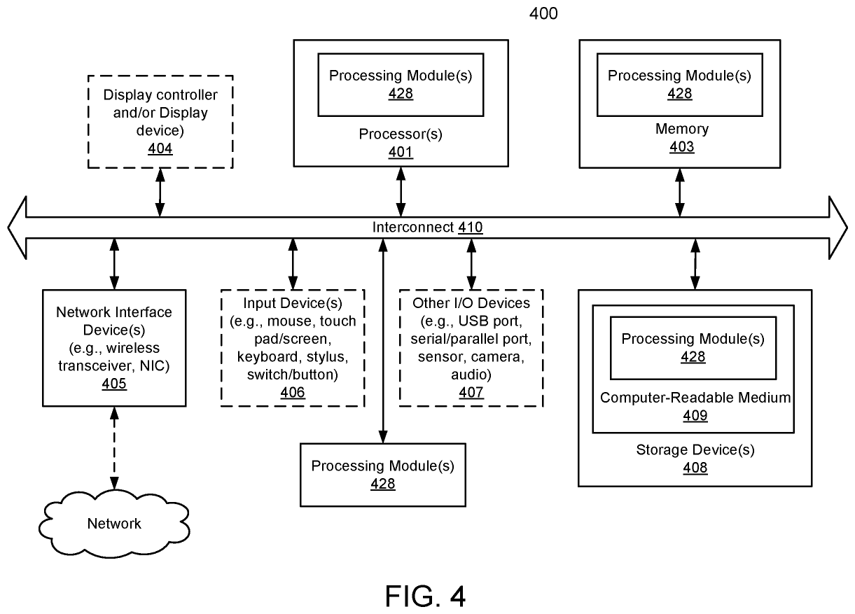

Any of client devices 100 and/or RMS 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

RMS 104 may be implemented with multiple computing devices. The computing devices of RMS 104 may cooperatively perform processes for managing customer-encountered issues. The computing devices of RMS 104 may perform similar and/or different functions, and may be used by different persons that may participate in the management of the customer-encountered issues. For example, RMS 104 may include multiple computing devices used by different service agents (e.g., persons) tasked with resolving customer-encountered issues. The service agents may attempt to utilize knowledge base articles to resolve the customer-encountered issues.

RMS 104 may be maintained, for example, by a business or other entity that has some degree of responsibility with respect to maintaining the operation of client devices 100. For example, RMS 104 may be operated by a business that sells client devices 100 and provides warranty or other types of support for client devices 100 to users and/or owners thereof.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

To further clarify embodiments disclosed herein, diagrams illustrating data flows implemented by and data structures used by a system over time in accordance with an embodiment are shown in FIGS. 2A-2B. In FIGS. 2A-2B, data structures are represented using a first set of shapes (e.g., 220-228) and processes are represented using a different set of shapes (e.g., 240-258).

Turning to FIG. 2A, a data flow diagram illustrating data flows, data processing, and/or other operations that may be performed by RMS 104 in accordance with an embodiment is shown.

To manage customer-encountered issues, RMS 104 may obtain service requests 220. Service requests 220 may be data structures that include information regarding the customer-encountered issues. Service requests 220 may be obtained by (i) obtaining information regarding the customer-encountered issues and (ii) adding the obtained information to a new or existing data structure representing a service request. The information may be obtained, for example, by (i) receiving the information via a portal (e.g., a website), (ii) receiving the information via phone calls, video calls, instant messages, and/or via other types of interactions with users (which may be subsequently subjected to processing to derive recordable information regarding the user and the customer encounter issue), and/or (iii) via other methods.

Service requests 220 may be analyzed to (i) identify cognitive loads 222 likely to be imposed on service agents tasked with working the service requests, and (ii) identify skill requirements 224 likely that need to be met by service agents to resolve the service requests. Cognitive loads 222 may be identified through calculation of intrinsic, extraneous, and germane components of a cognitive load likely to be placed on the service agents tasked with working service requests 220. Skill requirements 224 may be identified through taxonomic analysis of description of the customer-encountered issues upon which service requests 220 are based. The taxonomic analysis may facilitate classification of different customer-encountered issues into groups having similar taxonomic elements (e.g., terms) in the descriptions of the corresponding customer-encountered issues. Each grouping may be treated as requiring a skill associated with the group for a service agent to be proficient in resolving the service requests in the group. To identify service agents likely to have the skill, the past successful remediations of customer-encountered issues may be similarly classified into groups. The skill level for each skill of the service agents may be based on the number of service requests in each group that the service agent successfully remediated. These skills and skill levels may be stored as skill ratings 226.

When a service request of service requests 220 is obtained, the service request may drive service agent qualifying 240. Service agent qualifying 240 may use the cognitive loads 222, skill requirements 224, and skill ratings 226 to identify a set of qualified service agents. For example, the cognitive load for the service request may be used to identify a level of a service agent likely to be necessary to remediate the service request. The service agents may be part of a hierarchy that delineates them into different levels.

Similarly, the skill requirements for the service request may be compared to the skill ratings (e.g., 226) for the service agents to identify those service agents that likely have the skill necessary to remediate the service request. Service agents both of the level and having the necessary skill may be added to the qualified service agents (e.g., thereby delineating the qualified service agents from all of the service agents). In the event that a large number of service agents meet these criteria, then a number of the top ranked (e.g., based on skill level) service agents may be used as the qualified service agents.

While the qualified service agents may be likely to be able to resolve the service requests, the qualified service agents may be further ranked to identify a service agent that is likely to be able to remediate the customer-encountered issue in a time efficient manner. For example, the service agents may be ranked through proficiency ranking 242.

During proficiency ranking 242, proficiency metrics for the qualified service agents may be compared to obtain a ranking of the qualified service agents. The proficiency metrics may be stored in proficiency metrics 228, and these metrics may be based on performances of the service agents when attempting to resolve customer-encountered issues. For example, when a service request is resolved, metrics regarding the resolution process may be stored as part of proficiency metrics 228. These metrics may be used to establish relative and/or absolute ranking of the qualified service agents with respect to one another. Refer to FIG. 2B for additional details regarding obtaining the proficiency metrics.

Once proficiency ranking 242 is complete, ranked service agents may be available for additional analysis. For example, the rankings ascribed to the qualified service agents through proficiency ranking 242 may indicate which of the service agent is likely to most efficiently resolve the service request. However, because service agents may be tasked with resolving other service requests, it may not be desirable to always assign the service agent that is likely to most efficiently resolve the service request to work the service request.

To determine which of the qualified service agents to assign to work the service request, scheduling 244 may be performed. Scheduling 244 may take into account the ranking of the qualified service agents and other factors that may delay resolution of the service request if assigned to a particular service agent. These other factors may include (i) a current workload of the service agent, (ii) a location where the service agent is located and location where the service agent may need to travel to work the service request, (iii) a level of severity of impact of the customer-encountered issue associated with the service request, (iv) a level of financial cost for tasking the a service agent, (v) an existing level of cognitive load imposed on the service agent due to existing assignment, (vi) a cost (e.g., time, cognitive load, etc.) for switching from current assignments to working the service request, and (vii) a goal time for resolving the service request. For example, these factors may each be represented by a numerical value. Information usable to quantify these factors into the numerical value may be stored in a repository. The scores for these factors may be used to identify a service agent of the qualified service agents to work the service request.

The identified service agent may be assigned to work the service request. Once assigned, service request remediating 246 may be performed with the assigned service agent. For example, the assigned service agent may work the service request. Once the service request is remediated, documenting 250 may be performed so that the resolved service request is taken into account during future selections of service agents to work service requests.

For example, during documenting 248, the performance of the service agent may be analyzed to identify one or more metrics usable to quantify the proficiency of the service agent. The one or more metrics may be used to establish a cumulative metric that indicates the proficiency of the service agent. The cumulative metric may be normalized to a proficiency scale thereby allowing one to one comparisons between cumulative metrics for multiple service agents.

Refer to FIG. 2B for additional details regarding metrics identified during documenting 248.

By implementing the flow shown in FIG. 2A, a system in accordance with embodiments disclosed herein may be more likely to assign service agents that are likely to remediate the service requests in a time efficient. To select which service agents to assign to service customer-encountered issues, various proficiency metrics may be used.

Turning to FIG. 2B, a data flow diagram illustrating data flows, data processing, and/or other operations that may be performed by RMS 104 in accordance with an embodiment is shown. The processes illustrated in FIG. 2B may be used to update information sources upon which service agents are assigned to work service requests. FIG. 2B may be an expansion of documenting 248 shown in FIG. 2A.

After a service request is remediated (e.g., 230), a number of analyses (e.g., 250-258) may be performed. The analysis may be performed automatically and may be based on quantifiable information regarding performance of a service agent during a remediation process for remediated service request 230. The analyses may include resolution rate analysis 250 (e.g., through which resolution rate 230 may be identified), reopening rate analysis 252 (e.g., through which reopening rate 232 may be identified), first contact resolution rate analysis 254 (e.g., through which first contact resolution rate 234 may be identified), escalation rate analysis 256 (e.g., through which escalation rate 236 may be identified), and quantitative analysis 258 (through which proficiency metrics 248 may be identified).

During resolution analysis 250, a ratio of the previously remediated customer-encountered issues that were resolved by the service agent to a total of the previously remediated customer-encountered issues that were assigned to be resolved by the service agent is identified based on remediate service request 230. In other words, a ratio of successful (at least initially ascribed to be successful) to total attempts for resolving customer-encountered issues may be calculated.

During reopening rate analysis 252, a ratio of the previously remediated customer-encountered issues that were credited as resolved by the service agent but that were reopened for additional work toward being resolved to a total of the previously remediated customer-encountered issues that were assigned to be resolved by the service agent is identified based on remediate service request 230. In other words, a ratio of attempts at remediation that were marked as being successful but were reopening for additional work to the total attempts for resolving customer-encountered issues may be calculated.

During first contact resolution rate analysis 254, a ratio of the previously remediated customer-encountered issues that were credited as resolved by the service agent and that were not reopened for additional work toward being resolved to a total of the previously remediated customer-encountered issues that were assigned to be resolved by the service agent is identified based on remediate service request 230. In other words, a ratio of attempts at remediation that were complete successful (e.g., never reopened for additional work) to the total attempts for resolving customer-encountered issues may be calculated.

During escalation rate analysis 256, a ratio of previously remediated customer-encountered issues that were assigned to the service agent for resolution but that were subsequently resolved by a different service agent of the service agents to a total of the previously remediated customer-encountered issues that were assigned to be resolved by the service agent is identified based on remediate service request 230. In other words, a ratio of attempts at remediation that were unsuccessful and escalated to be worked on both other service agents to the total attempts for resolving customer-encountered issues may be calculated.

To further clarify analyses 250-256, consider a scenario where a service agent is assigned 10 service requests, successfully resolves 6 of the service requests without any reopening for work on the service requests after the service requests are credited as being remediated, successfully resolves 3 of the service requests with at least one reopening for work on the service requests after the service requests are credited as being remediated, and is unsuccessful in resolving 1 service request which is subsequently escalated to be worked on by other service agents. In this scenario, resolution rate 230 is 0.9 ((6+3)/10), reopening rate 232 is 0.3 ((3)/10), first contact resolution rate 234 is 0.6 ((6)/10), and escalation rate 236 is 0.1((1)/10).

Rates 230-236 may be used to drive quantitative analysis 258 to obtain proficiency metrics 238. During quantitative analysis 258, the rates may be quantitively analyzed to identify proficiency metrics 238. For example, a function that relates the rates (230-236) to proficiency metrics 238 may be used. The rates may be ingested into the function and proficiency metrics 238 may be output from the function.

For example, the function may be a weighted sum (e.g., A*resolution rate 230+B*reopening rate 232+C*first contact resolution rate 234+D*escalation rate 236=Proficiency metrics 238, where A-D are constants selected based on judgement of an administrator, a subject matter expert, and/or other basis) that outputs proficiency metrics 238. The output of the function may be normalized to a scale for the service agents. For example, if the scale for the service agents is a discrete scale with levels 1, 2, 3, 4, and 5, then the value from the function may be (i) scaled to a 0-5 scale and (ii) rounded to a nearest integer. Proficiency metrics 238 may be scaled/normalized differently, may not be scaled and/or normalized, and/or may take into account additional and/or different factors (e.g., rates or other performance quantization) without departing from embodiments disclosed herein.

Once obtained, proficiency metrics 238 may be used to update proficiency metrics 228 thereby integrating the performance of the service agent with respect to remediated service request 230 into future service agent assignment processes (e.g., scheduling 244).

Thus, via the processes illustrated in FIG. 2B, a system in accordance with an embodiment may automatically record information usable to make service agent assignments in the future that are more likely to meet goals for resolving service requests (e.g., time goals, financial goals, etc.).

In an embodiment, RMS 104 is implemented using a hardware device including circuitry. The hardware device may be, for example, a digital signal processor, a field programmable gate array, or an application specific integrated circuit. The circuitry may be adapted to cause the hardware device to perform the functionality of RMS 104 such as service agent qualifying 240, proficiency ranking 242, scheduling 244, service request remediating 246, document 248, resolution rate analysis 250, reopening rate analysis 252, first contact resolution rate analysis 254, escalation rate analysis 256, quantitative analysis 258, and/or other processes. RMS 104 may be implemented using other types of hardware devices without departing embodiment disclosed herein.

In one embodiment, RMS 104 is implemented using a processor adapted to execute computing code stored on a persistent storage that when executed by the processor performs the functionality of RMS 104 discussed throughout this application such as service agent qualifying 240, proficiency ranking 242, scheduling 244, service request remediating 246, document 248, resolution rate analysis 250, reopening rate analysis 252, first contact resolution rate analysis 254, escalation rate analysis 256, quantitative analysis 258, and/or other processes. The processor may be a hardware processor including circuitry such as, for example, a central processing unit, a processing core, or a microcontroller. The processor may be other types of hardware devices for processing information without departing embodiment disclosed herein.

In an embodiment, RMS 104 includes storage which may be implemented using physical devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage may include a memory device (e.g., a dual in line memory device) in which data is stored and from which copies of previously stored data are provided. In another example, storage may include a persistent storage device (e.g., a solid-state disk drive) in which data is stored and from which copies of previously stored data is provided. In a still further example, storage may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage may store data structures including service requests 220, cognitive loads 222, skill requirements 224, skill ratings 226, and proficiency metrics 228, and/or other data structures. Any of these data structures may be implemented using, for example, lists, tables databases, linked lists, unstructured data, and/or other types of data structures.

As discussed above, the components of FIG. 1 may perform various methods to manage customer-encountered issues. FIG. 3 illustrates methods that may be performed by the components of FIG. 1. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of resolving customer-encountered issues in accordance with an embodiment is shown. The method may be performed by RMS 104 or other components of the system shown in FIG. 1.

At operation 300, a portion of service agents that are qualified to handle a customer-encountered issue are identified. The portion of the service agents may be identified through (i) cognitive load estimation to identify a service agent level likely to be able to resolve the customer-encountered issue, (ii) a skills analysis to identify skills likely to be needed to resolve the customer-encountered issue and service agents having the skills, and/or (iii) other types of analyses. The cognitive load estimation, skill analysis, and/or other analyses may discriminate the portion of the service agents from other service agents.

At operation 302, the service agents of the portion of the service agents may be ranked based on proficiency level estimates for resolving the customer-encountered issue by the service agents to obtain a ranking. The proficiency level estimates may be based on historical performance of the service agents and an automated quantification model.

The proficiency level estimates may be obtained by reading proficiency metrics for the portion of the service agents from a data structure. The proficiency metrics may include numerical values representing the proficiency levels of the service agents based on past remediations of service requests for customer-encountered issues. The numerical values may be used as the proficiency level estimates for the service agents.

The ranking may be obtained by ordering the service agents based on the numerical values of the proficiency level estimates. For example, if three service agents are ascribed proficiency level estimates of 1, 3 and 4, respectively, then the third service agent may be ranked as most proficient, the second service agent as the second most proficient, and the first service agent as the least proficient.

At operation 306, a service agent of the service agents is selected to remediate the customer-encountered issue based on the ranking. The service agent may be selected through a scheduling analysis that further ranks the service agents based on their current workload, existing cognitive load (e.g., due to existing work assignment), change in cognitive load should a service agent be assigned to remediate the customer-encountered issue, and/or other factors that may indicate when a service agent is likely to be able to resolve the customer-encountered issue. Additionally, other factors such as a financial cost per unit time ascribed to each service agent may be taken into account. These factors and the rankings may be used to identify the service agent to select through, for example, evaluation of an objective function or other tool for multivariate analysis and optimization. The objective function may take the rankings and factors as input, ascribe numerical values usable to relatively rank the service agents, and the best ranked service agent may be selected. Through the scheduling analysis, the highest ranked service agent may or may not be selected to remediate the customer-encountered issue, depending on the impact of the other factors considered during the scheduling analysis.

For example, if the highest ranked service agent has a very high workload which may prevent the highest ranked service agent from starting to work on the customer-encountered issue prior to when a time goal to resolve the customer-encountered issue expires, then a different service agent (e.g., perhaps the second highest ranked service agent) that has a lower workload may be selected to work the customer-encountered issue.

At operation 308, the customer-encountered issue is resolved by assigning the selected service agent to work the customer-encountered issue. The service agent may be assigned by, for example, populating a workflow management system or other system with information indicating that the assigned service agent is responsible for resolving the customer-encountered issue.

The method may end following operation 308.

Once the customer-encountered issue is resolved, information regarding the customer-encountered issue and the service agent's performance during the resolution may be used to update information upon which future service agent selections are made, as described with respect to FIG. 2B.

Using the method illustrated in FIG. 3, a system in accordance with an embodiment may assign service requests to service agents that are more likely to resolve customer-encountered issue within prescribed goals.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac Os®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing customer-encountered issues using service agents, the method comprising:
identifying a portion of the service agents that are qualified to handle a customer-encountered issue of the customer-encountered issues;
ranking the service agents of the portion of the service agents based on proficiency level estimates for resolving the customer-encountered issue by the service agents to obtain a ranking for the portion of the service agents, the proficiency level estimates being based on historical performance of the service agents and an automated quantification model;
selecting a service agent of the service agents to remediate the customer-encountered issue based on the ranking; and
resolving the customer-encountered issue by assigning the selected service agent to work the customer-encountered issue.

2. The method of claim 1, wherein the automated quantification model provides, for a service agent of the service agents, a proficiency level estimate of the proficiency level estimates based on a group of rates consisting of:
a resolution rate of previously remediated customer-encountered issues by the service agent;
a reopening rate of the previously remediated customer-encountered issues by the service agent;
a first contact resolution rate of the previously remediated customer-encountered issues by the service agent; and
an escalation rate of the previously remediated customer-encountered issues by the service agent.

3. The method of claim 2, wherein the resolution rate indicates a ratio of the previously remediated customer-encountered issues that were resolved by the service agent to a total of the previously remediated customer-encountered issues that were assigned to be resolved by the service agent.

4. The method of claim 3, wherein the reopening rate indicates a ratio of the previously remediated customer-encountered issues that were credited as resolved by the service agent but that were reopened for additional work toward being resolved to a total of the previously remediated customer-encountered issues that were assigned to be resolved by the service agent.

5. The method of claim 4, wherein the first contact resolution rate indicates a ratio of the previously remediated customer-encountered issues that were credited as resolved by the service agent and that were not reopened for additional work toward being resolved to a total of the previously remediated customer-encountered issues that were assigned to be resolved by the service agent.

6. The method of claim 5, wherein the escalation rate indicates a ratio of the previously remediated customer-encountered issues that were assigned to the service agent for resolution but that were subsequently resolved by a different service agent of the service agents to a total of the previously remediated customer-encountered issues that were assigned to be resolved by the service agent.

7. The method of claim 6, wherein the proficiency level estimate of the proficiency level estimates is obtained using a weighted sum of the group of rates that is normalized to a proficiency level scale for the service agents.

8. A non-transitory machine-readable medium having instructions stored therein, which when executed by a processor, cause the processor to perform operations for managing customer-encountered issues using service agents, the operations comprising:
identifying a portion of the service agents that are qualified to handle a customer-encountered issue of the customer-encountered issues;
ranking the service agents of the portion of the service agents based on proficiency level estimates for resolving the customer-encountered issue by the service agents to obtain a ranking for the portion of the service agents, the proficiency level estimates being based on historical performance of the service agents and an automated quantification model;
selecting a service agent of the service agents to remediate the customer-encountered issue based on the ranking; and
resolving the customer-encountered issue by assigning the selected service agent to work the customer-encountered issue.

9. The non-transitory machine-readable medium of claim 8, wherein the automated quantification model provides, for a service agent of the service agents, a proficiency level estimate of the proficiency level estimates based on a group of rates consisting of:
a resolution rate of previously remediated customer-encountered issues by the service agent;
a reopening rate of the previously remediated customer-encountered issues by the service agent;
a first contact resolution rate of the previously remediated customer-encountered issues by the service agent; and
an escalation rate of the previously remediated customer-encountered issues by the service agent.

10. The non-transitory machine-readable medium of claim 9, wherein the resolution rate indicates a ratio of the previously remediated customer-encountered issues that were resolved by the service agent to a total of the previously remediated customer-encountered issues that were assigned to be resolved by the service agent.

11. The non-transitory machine-readable medium of claim 10, wherein the reopening rate indicates a ratio of the previously remediated customer-encountered issues that were credited as resolved by the service agent but that were reopened for additional work toward being resolved to a total of the previously remediated customer-encountered issues that were assigned to be resolved by the service agent.

12. The non-transitory machine-readable medium of claim 11, wherein the first contact resolution rate indicates a ratio of the previously remediated customer-encountered issues that were credited as resolved by the service agent and that were not reopened for additional work toward being resolved to a total of the previously remediated customer-encountered issues that were assigned to be resolved by the service agent.

13. The non-transitory machine-readable medium of claim 12, wherein the escalation rate indicates a ratio of the previously remediated customer-encountered issues that were assigned to the service agent for resolution but that were subsequently resolved by a different service agent of the service agents to a total of the previously remediated customer-encountered issues that were assigned to be resolved by the service agent.

14. The non-transitory machine-readable medium of claim 13, wherein the proficiency level estimate of the proficiency level estimates is obtained using a weighted sum of the group of rates that is normalized to a proficiency level scale for the service agents.

15. A data processing system, comprising:
a processor; and
a memory coupled to the processor to store instructions, which when executed by the processor, cause the processor to perform operations for managing customer-encountered issues using service agents, the operations comprising:
identifying a portion of the service agents that are qualified to handle a customer-encountered issue of the customer-encountered issues;
ranking the service agents of the portion of the service agents based on proficiency level estimates for resolving the customer-encountered issue by the service agents to obtain a ranking for the portion of the service agents, the proficiency level estimates being based on historical performance of the service agents and an automated quantification model;
selecting a service agent of the service agents to remediate the customer-encountered issue based on the ranking; and
resolving the customer-encountered issue by assigning the selected service agent to work the customer-encountered issue.

16. The data processing system of claim 15, wherein the automated quantification model provides, for a service agent of the service agents, a proficiency level estimate of the proficiency level estimates based on a group of rates consisting of:
a resolution rate of previously remediated customer-encountered issues by the service agent;
a reopening rate of the previously remediated customer-encountered issues by the service agent;
a first contact resolution rate of the previously remediated customer-encountered issues by the service agent; and
an escalation rate of the previously remediated customer-encountered issues by the service agent.

17. The data processing system of claim 16, wherein the resolution rate indicates a ratio of the previously remediated customer-encountered issues that were resolved by the service agent to a total of the previously remediated customer-encountered issues that were assigned to be resolved by the service agent.

18. The data processing system of claim 17, wherein the reopening rate indicates a ratio of the previously remediated customer-encountered issues that were credited as resolved by the service agent but that were reopened for additional work toward being resolved to a total of the previously remediated customer-encountered issues that were assigned to be resolved by the service agent.

19. The data processing system of claim 18, wherein the first contact resolution rate indicates a ratio of the previously remediated customer-encountered issues that were credited as resolved by the service agent and that were not reopened for additional work toward being resolved to a total of the previously remediated customer-encountered issues that were assigned to be resolved by the service agent.

20. The data processing system of claim 19, wherein the escalation rate indicates a ratio of the previously remediated customer-encountered issues that were assigned to the service agent for resolution but that were subsequently resolved by a different service agent of the service agents to a total of the previously remediated customer-encountered issues that were assigned to be resolved by the service agent.
